(19) United States
(12) Patent Application Publication
(10) Pub. No.: US 2008/0183748 A1
(43) Pub. Date: Jul. 31, 2008

(54) Data Processing System And Method

(76) Inventor: Maruti Haridas Kamat, Bangalore Karnataka, IN (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 12/022,016

(22) Filed: Jan. 29, 2008

(30) Foreign Application Priority Data
Jan. 31, 2007 (IN) 212/CHE/2007

(51) Int. Cl. G06F 17/30

(52) U.S. Cl. 707/103 R; 707/E17.001

(57) ABSTRACT

A method of storing an object in a multimedia message database, the method comprising:
determining a location of free space in a data file from a free space map (FSM) associated with a data file;
storing at least part of the object at the location in the data file;
updating the free space map to indicate that the location is no longer free; and
updating the multimedia message database to indicate the location of the object in the data file.

### BACKGROUND TO THE INVENTION

A database system, for example for storing multimedia messages, may store large objects (LOBs) in a separate file, and include a link in the database that points to the object. A large object is an object that exceeds a threshold size. For multimedia messages in a multimedia messaging system (MMS), a typical threshold size is 4 kilobytes (KB).

FIG. 1 shows an example of a mobile network 100 that includes subscriber A 102 and subscriber B 104. Each of the subscribers 102 and 104 may communicate with a mobile service provider server 106. When subscriber A 102 sends an object, such as a multimedia message, to subscriber B 104, the communications device (such as a mobile telephone) of subscriber A 102 sends the object to the mobile service provider server 106. The server 106 stores the object in a database and informs the communications device of subscriber B 104 that an object is available. The communications device of subscriber B 104 then attempts to download the object from the server 106. If the object is downloaded successfully, then the server 106 deletes the object from the database.

FIG. 2 shows an example of a database 200 for storing objects, such as multimedia messages. The database 200 includes a first table 202 and a second table 204, the tables 202 and 204 being used to store objects. When a large object (LOB) is received, the object is stored in a shared data segment 206. The data file comprises multiple equally-sized blocks 208. Each block can hold one object, or part of one object. Where an object is larger than the block size, the object is split up between multiple blocks. Where an object or part of an object in a block is smaller than the block size, then the remaining space in the block is wasted. For example, where the block size is 1 MB, and an object to be stored is 1.5 MB in size, then the object will occupy 1 MB of one block and 0.5 MB of another block. 0.5 MB of space in the second block is wasted. Storing large objects in the database 200 is slow, as the large object data must be stored in the database transaction logs to preserve database atomicity. Another database 300 shown in FIG. 3 includes a table 302 for storing objects. A data file 304 external to the operating system stores large objects within equally sized blocks 306. Metadata associated with the object, such as object ID, size of the object, location of the object within the data file 304 and timestamp when the object was added to the data file 304 are stored in a metadata file 308 external to the database 300. Links in the table 302 point to the object's entries in the metadata file 308.

Objects are stored in chunks within the data file 304. A chunk comprises a fixed number of blocks 306. If an object or part of an object stored in a chunk is smaller than the chunk size, then unused space in the chunk is wasted. Where an object is larger than the chunk size, the object is stored in multiple chunks. These chunks may be stored at random locations within the data file 304. Reading and writing these fragmented objects may then become costly operations, and a complex index structure is required to indicate the locations of the chunks of the objects in the data file 304. Furthermore, a complex index structure such as a B−tree, B+tree or hash index is required to identify used and free blocks and chunks in the data file 304.

### BRIEF DESCRIPTION OF THE DRAWINGS

Embodiments of the invention will now be described by way of example only, with reference to the accompanying drawings, in which:

FIG. 1 shows an example of a mobile network;

FIG. 2 shows an example of a first known database;

FIG. 3 shows an example of a second known database;

FIG. 4 shows an embodiment of a storage system according to embodiments of the invention;

FIG. 5 shows an example of a plurality of data files;

FIG. 6 shows an example of a method of storing an object according to embodiments of the invention;

FIG. 7 shows an example of a method of storing an object in more detail; and

FIG. 8 shows an example of a data processing system suitable for implementing embodiments of the invention.

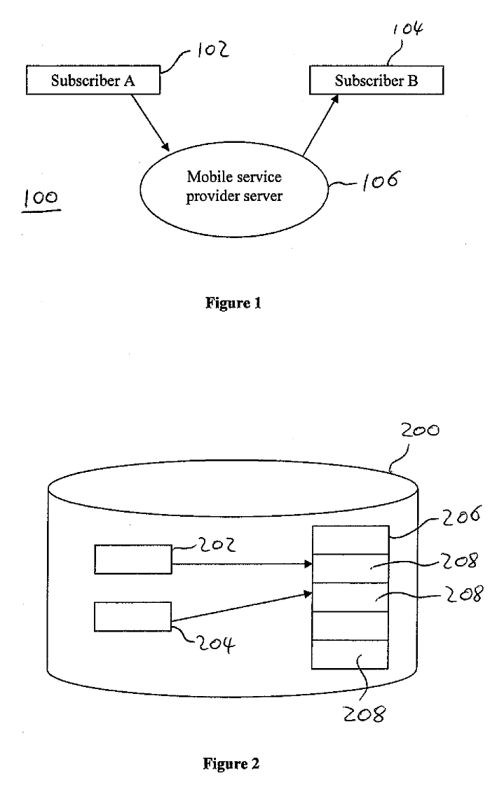

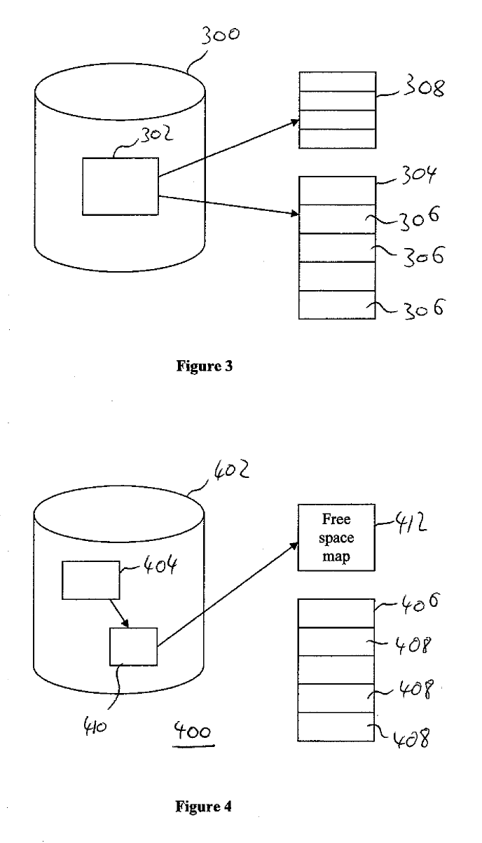

### DETAILED DESCRIPTION OF EMBODIMENTS OF THE INVENTION

Embodiments of the invention may be used to store large objects (LOBs), such as multimedia messages. Inserting, reading and deleting objects are fast and efficient operations and database atomicity is preserved. Embodiments of the invention store the objects such that less space is wasted compared to known large object storage systems.

FIG. 400 shows a storage system 400 according to embodiments of the invention. The system 400 comprises a database 402 for storing objects such as multimedia messages. Objects which are not large objects are stored within a table 404. A large object may be stored in one of a plurality of data files, and one data file 406 is shown for clarity. The data file 406 comprises a plurality of equally-sized blocks 408. An entry in the table 404 for each large object points to a corresponding entry in a metadata table 410. The metadata table 410 stores metadata corresponding to large objects, such as object ID, timestamp that it was stored in the system 400, size of the object and location of a byte in a free space map (FSM) file 412 associated with the data file 406.

The free space map (FSM) file 412 contains as many bytes as there are blocks in the data file 406. Each byte in the FSM file 412 corresponds to one of the blocks in the data file 406 in the corresponding location. For example, byte 1 of the FSM file 412 corresponds to block 1 of the data file 406, byte 2 of the FSM file 412 corresponds to block 2 of the data file 406, and so on. The bytes of the FSM file 412 indicate whether the corresponding block in the data file 406 is free space or whether the block contains data. In certain embodiments, for example, a byte value of 0 in the FSM file 412 indicates that the corresponding block in the data file 406 is free space, whereas a byte value of 1 indicates that the corresponding block contains an object or part of an object. As the location of a byte in the FSM file 412 indicates the location of the corresponding block, then the data in the metadata table 410 indicating the location of a byte in the FSM file 412 can also be used to determine the location of the corresponding block in the date file 406.

Although in embodiments of the invention, a byte in the FSM file corresponds to a block in the data file, in alternative embodiments, a different amount of data in the FSM file may correspond to a block in the data file. For example, in alternative embodiments, a bit in the FSM file corresponds to a block in the data file. This may reduce the size of the FSM file compared to where a byte corresponds to a block.

FIG. 5 shows a plurality of data files 500. A first data file 502 contains a single block 504 of size 2̂13 bytes, that is, the block size of the first data file 502 is 8 KB. A second data file 506 contains two blocks 508 of size 2̂12 bytes, or 4 KB. A third data file 510 contains four blocks 512 of size 2̂11 bytes, or 2 KB. A fourth data file 514 contains eight blocks 516 of size 2̂10 bytes, or 1 KB. A fifth data file 518 contains sixteen blocks 520 of size 2̂9 bytes, or 512 bytes. Thus, the data files are all of equal size, and a single data file only contains blocks of a single size, although the block size varies between data files such that no two data files contain the same size blocks.

Each of the data files 500 is associated with a corresponding free space map (FSM) file (not shown). The FSM file associated with a data file indicates which blocks are occupied by objects or parts of objects and which blocks comprise free space, in a manner identical to that described in respect of FSM file 412 and data file 406 above. Thus, for example, the size of the FSM file associated with the first data file 502 is a single byte, whereas the size of the FSM file associated with the fifth data file is sixteen bytes.

Although there are five data files 500 shown in FIG. 5, and the block size differs between files in powers of two, in alternative embodiments there may be any number of data files with any size block. Two or more data files may contain the same size blocks. Each data file also may be of any size.

Embodiments of the invention use the plurality of data files 500 to store large objects, according to one of two storage algorithms. The first algorithm, the best performance algorithm, is used to store an object as quickly as possible. Therefore, the smallest block that will contain the entire object is chosen. For example, where an object of size 6.4 KB is to be stored, then the first data file 502 is chosen to store the object as the block size is 8 KB which is suitable for storing the whole object. The next smaller block size, 4 KB in the data file 506, is not sufficient to store the entire object.

The second algorithm, the best space algorithm, splits the object into multiple blocks that are stored in multiple data files. The largest block size used is the largest size that cannot contain the whole object. For example, if the object of size 6.4 KB is to be stored according to the best space algorithm, then a part of an object comprising the first 4 KB is stored in the second data file 506. The remaining data of the object is then handled in the same manner. For example, the next 2 KB of the remaining 2.4 KB is stored in the third data file 510. The remaining 0.4 KB is stored in the fifth data file 518, in a single block 520. This is because there is no smaller size for storing part of the remaining 0.4 KB of the object.

Therefore, with the best space algorithm, 0.1 KB of space is wasted, whereas with the best performance algorithm, 1.6 KB is wasted. Therefore, the best space algorithm reduces the space wasted by a stored object compared to the best performance algorithm, although storing an object using the best space algorithm generally requires more disk accesses to store the various object parts. The FSM files corresponding to the data files used are updated appropriately, for example the bytes corresponding to used blocks are set to 1.

The storage algorithm that is used may be fixed for the storage system 400. Alternatively, storage algorithm may be determined for the system 400 by specifying a maximum percentage of wasted space in the data files 500. Once the maximum percentage is specified, the appropriate storage algorithm may be fixed, or chosen for each object to be stored depending on its size and the percentage of the smallest block that would hold the object that is wasted.

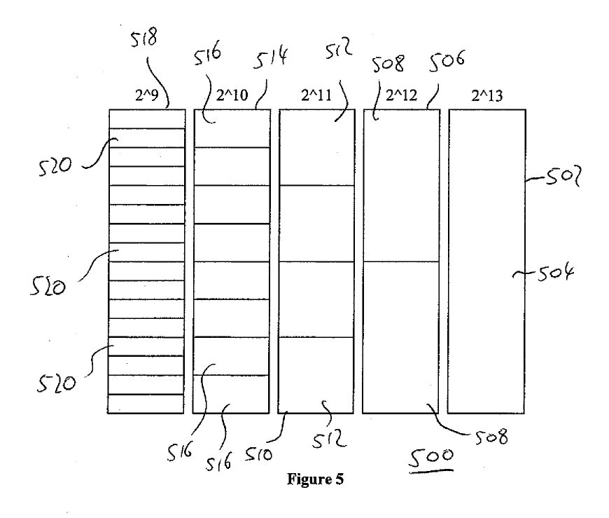

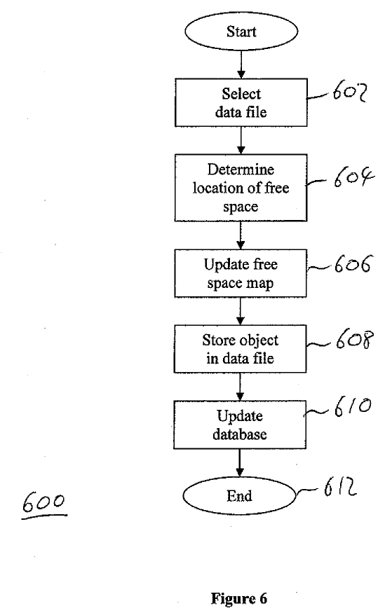

FIG. 6 shows an example of a method 600 for storing an object in the storage system 400 according to embodiments of the invention. The method starts at step 602 where a storage file is selected according to the chosen storage algorithm as indicated above. Next, in step 604, the location of a block of free space in the selected data file is determined from the free space map (FSM) file associated with the selected data file. In step 606, which follows from step 604, the free space map is updated to indicate that the block of free space located in step 604 is no longer free. Next, in step 608, the object or part of the object is stored in the block in the selected data file. Then, in step 610, the database is updated so that the metadata table 410 shown in FIG. 4 includes an entry that corresponds to the object and that the entry points to the appropriate part of the appropriate FSM file or files. Where a part of the object was stored in step 608, and a part of the object still remains to be stored, then steps 602 to 608 may be repeated for the remaining part of the object. From step 610, the method 600 ends at step 612.

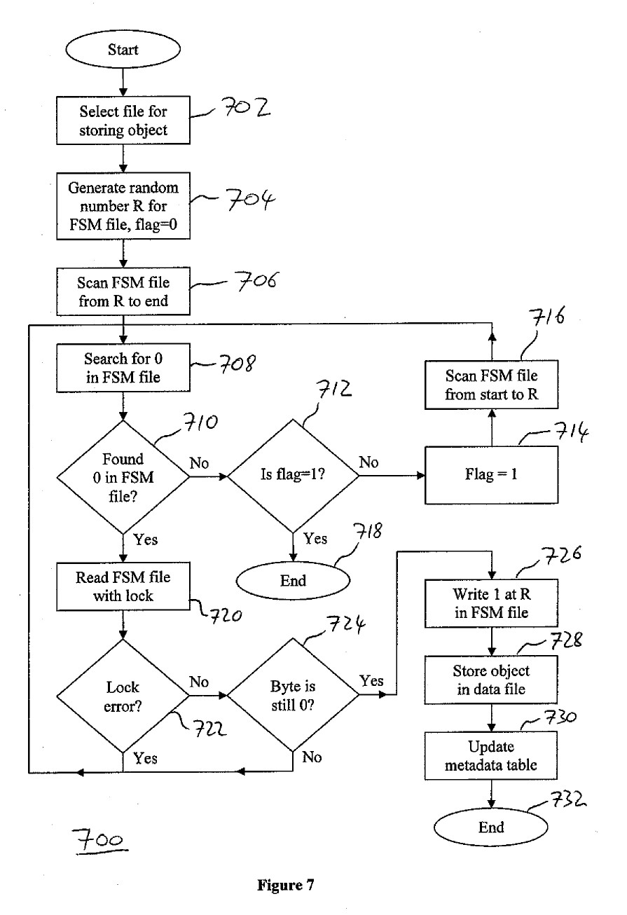

FIG. 7 shows a method 700 of storing a large object in more detail. The method 700 starts from step 702, where a data file is selected for storing the object or part of the object as above. Next, in step 704, a random number R is generated, and a flag is set to 0. The random number R is between 1 and the length of the FSM file associated with the selected data file inclusive. The method 700 then proceeds to step 706 where the FSM file is scanned starting from byte number R to find a byte 0, indicating a block of free space in the associated data file.

The search through the FSM file is started from a random location in case of multiple requests for storing large objects that cause substantially simultaneous searches through the same FSM file. If the searches were all started from the same point, for example from byte 1 of the FSM file, then this may lead to congestion as all of the requests “compete” for the same blocks of the associated data file. Starting the search from a random location alleviates this problem by spreading substantially simultaneous searches apart.

From step 706, the method proceeds to step 708 where the FSM file is searched for a byte 0. If a byte 0 is found, the end of the FSM file is reached, or the byte R is reached (as indicated below), then the method 700 proceeds to step 710 where it is determined whether a byte 0 was found. If a byte 0 was not found, then the status of the flag is tested in step 712. If the flag is still 0, then the end of the FSM file was reached, and the flag is set to 1 in step 714. Next, in step 716, the scan through the FSM file is reset to the start of the FSM file, and then the method continues from step 708 once again where the search for a byte 0 is continued. If it was determined in step 712 that the flag is 1, then the whole FSM file has been searched, and a byte 0 has not been found. Therefore, the corresponding selected data file is full, and the object cannot be stored in the selected data file. The method 700 then ends at step 718. The method 700 may be repeated so that the selected data file cannot be selected again, and in such a case the method would attempt to store the object or part of the object in an alternative data file.

If it was determined in step 710 that a byte 0 was found in the FSM file, then the method proceeds from step 710 to step 720, where the FSM file is read again, but with a lock on the byte 0 found. Next, in step 722, it is determined whether the request for a lock was successful. If not, then the byte found may have been locked in order to store another object. For example, another instance of the method 700 may be proceeding in parallel in respect of another object. Therefore, the method returns to step 708, to search for a different byte 0 in the FSM file.

If it was determined in step 722 that the lock was successful, the method checks in step 724 that the byte 0 found is still set to 0. If this is not the case, then the byte may have been set to 1 (and then unlocked, if it was locked) in order to store another object. Therefore, the method returns to step 708, to search for a different byte 0 in the FSM file.

If the byte is still at 0, then the method 700 for storing the object has control over the byte 0 found and therefore has control over the corresponding block in the associated data file, which are currently free space. The method therefore proceeds from step 724 to step 726, where the byte found in step 708 is set to 1, indicating that the corresponding block in the data file is no longer free. Next, in step 728, the object or part of the object is written to the corresponding block in the data file. Then, in step 730, the metadata table 404 shown in FIG. 4 is updated as indicated above in respect of step 610 of the method 600 of FIG. 6, and the lock on the byte is released. The method 700 then ends at step 732.

Thus, the object or part of the object has been successfully written to a data file, and the associated FSM has been updated. The method 700 can deal with other objects being stored in the same data file at the same time (such as, for example, multiple instances of the method 700 storing objects in the same data file) by using the associated free space map (FSM) file and locks on selected bytes, and by starting the search for free space from random locations to avoid congestion.

Embodiments of the invention maintain database atomicity, so that the act of storing an object or part of an object in a data file (and the associated changes to the FSM file) can be undone, or backed out, if necessary. This may be necessary due to, for example, failure of a data processor in a data processing system implementing embodiments of the invention, when a process or thread implementing embodiments of the invention in a data processing system is “killed”, or some other reason.

Data required for backing out of a transaction is stored in a transaction log. Changes made to the free space map (FSM) files associated with the data files are stored in the transaction log file. Changes made to the metadata table 410 of FIG. 4 may also be stored in the transaction log. However, changes made to the data files are not stored in the transaction log. This is because if any data in a data file is overwritten, the data was marked as free space as indicated in the associated FSM file. The data has therefore been used, for example been downloaded by a mobile subscriber, and is no longer needed. A record of the data in the transaction log is therefore not required.

If a transaction to store an object causes changes to be made to the metadata table 410, a FSM file and an associated data file, and then the transaction must be backed out, the changes made to the metadata table 410 are undone using data from the transaction log, and the changes made to the FSM file are undone using data from the transaction log. The changes made to the data file are not undone, as the blocks used are marked as free space before and after the transaction, and so the data contained in the blocks is not significant. The transaction log may be updated to reflect that the transaction was backed out. Thus, atomicity of the storage system is achieved without storing the object data on the transaction logs. This speeds up transactions compared to systems where object data is included within the transaction log, and may also reduce the size of the transaction log.

When deleting an object from the storage system, such as, for example, when a mobile subscriber has downloaded the object, the FSM file associated with the data file that stores the object is changed from a 1 to a 0, after acquiring a lock on that byte. The metadata table 410 in FIG. 4 is then updated to remove the entry corresponding to the object and then the lock on the byte in the FSM file is released, signifying that the delete transaction is complete. These changes are stored in the transaction log, and therefore transaction atomicity is preserved. For example, if the delete transaction is to be backed out before it is complete, the changes made to the metadata table 410 can be undone using data from the transaction log, and the changes made to the FSM file can be undone using data from the transaction log. Atomicity is achieved without storing any of the data in the data file in the transaction log, and deletion is also achieved without modifying the data file at all. Therefore, the performance of a delete transaction is improved compared to a similar transaction in known storage systems. The lock on the byte of the FSM file ensures that after the byte has been changed to 0, the associated block in the data file cannot be overwritten (as the byte in the FSM file must first be changed to 1) until the transaction is complete, thus preserving the object in the data file until the transaction is complete.

Embodiments of the invention may monitor the data files and/or the FSM files to determine when there are no blocks of free space within a data file. When there are no blocks of free space in a data file, the data file and/or the associated FSM file may be marked as “closed” or “full” such that the data file cannot be selected for storing a new object. When blocks in the data file become free, as reflected by the associated FSM file, the data file may be marked as “open” or available for storing a new object. In this way, the FSM file associated with a full data file is not processed (for example, is not searched in the method 700 of FIG. 7) when storing an object.

The data files 500 of FIG. 5 and their associated FSM files (not shown) form a set of data files. When the data files 500 become full, or one or more of the data files 500 become full, then a new set of data files and associated FSM files may be created for storing large objects. One or more data files in the new set may then be selected for storing an object (for example, selected in the method 700 of FIG. 7). The metadata table 410 of FIG. 4 may indicate the set in which an object is stored.

A new set of data files may be added at any time. For example, a data processing system that implements embodiments of the invention may include one or more permanent storage devices (such as, for example, hard disks) for storing one or more sets of data files and associated FSM files. One or more storage devices may be added to the data processing system, and one or more sets of data files may be created and stored on the new storage devices. For example, each new storage device may store one set of data files, although this is not a requirement. Similarly, one or more storage devices may be removed from the data processing system, and the sets of data files stored thereon may be deleted. Thus, embodiments of the invention are scalable in terms of the amount of storage that can be used in a data processing system that implements embodiments of the invention.

Because of the nature of the storage system according to embodiments of the invention, which stores multimedia messages sent by one subscriber to another, an update transaction, which can be complex to implement, is not required.

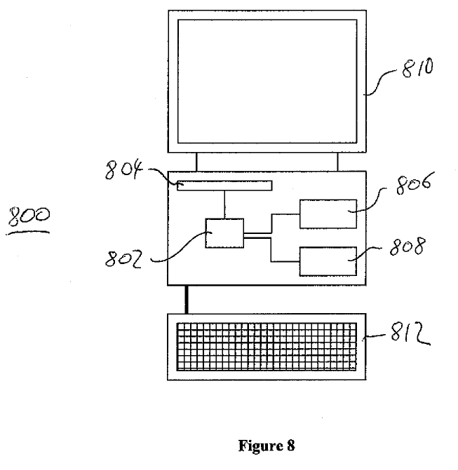

FIG. 8 shows a data processing system 800 that is suitable for implementing embodiments of the invention. The system 800 comprises a data processor 802 and a main memory 804. The system 800 also comprises a permanent storage device 806, such as a hard disk, and may also include a communications device 808 for communicating with an external wired and/or wireless network, such as, for example, a LAN, WAN, internet or other network. The system 800 may also include a display device 810 and an input device 812 such as, for example, a keyboard and/or mouse.

It will be appreciated that embodiments of the present invention can be realised in the form of hardware, software or a combination of hardware and software. Any such software may be stored in the form of volatile or nonvolatile storage such as, for example, a storage device like a ROM, whether erasable or rewritable or not, or in the form of memory such as, for example, RAM, memory chips, device or integrated circuits or on an optically or magnetically readable medium such as, for example, a CD, DVD, magnetic disk or magnetic tape. It will be appreciated that the storage devices and storage media are embodiments of machine-readable storage that are suitable for storing a program or programs that, when executed, implement embodiments of the present invention. Accordingly, embodiments provide a program comprising code for implementing a system or method as claimed in any preceding claim and a machine readable storage storing such a program. Still further, embodiments of the present invention may be conveyed electronically via any medium such as a communication signal carried over a wired or wireless connection and embodiments suitably encompass the same.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed. The claims should not be construed to cover merely the foregoing embodiments, but also any embodiments which fall within the scope of the claims.

1. A method of storing an object in a multimedia message database, the method comprising:
determining a location of free space in a data file from a free space map (FSM) associated with a data file;
storing at least part of the object at the location in the data file;
updating the free space map to indicate that the location is no longer free; and
updating the multimedia message database to indicate the location of the object in the data file.

2. A method as claimed in claim 1, comprising maintaining a log file for undoing the storing, the log file indicating changes made to the free space map and the multimedia message database.

3. A method as claimed in claim 1, wherein determining the location of free space in the data file comprises selecting the data file from a plurality of data files, each data file comprising a plurality of equally sized blocks.

4. A method as claimed in claim 3, wherein each data file is associated with a respective free space map, and determining the location of free space comprises determining the location of free space in the selected data file from the associated free space map.

5. A method as claimed in claim 3, wherein the blocks in the respective data files comprise blocks of respective sizes.

6. A method as claimed in claim 3, comprising monitoring the plurality of data files, and marking data files as closed when they are full.

7. A method as claimed in claim 1, wherein determining the location of free space comprises searching through the free space map from a random location.

8. A multimedia message storage system, comprising:
at least one data file for storing objects;
at least one free space map indicating free space in a respective one of the at least one data file; and
a multimedia message database indicating the locations of the objects in the at least one data file.

9. A system as claimed in claim 8, wherein the at least one data file comprises a plurality of data files.

10. A system as claimed in claim 9, wherein each data file comprises a plurality of blocks of a size associated with the data file.

11. A system as claimed in claim 8, comprising a log of transactions made to the at least one free space map and the multimedia message database.

12. A computer program for storing a storing an object in a multimedia message database, the computer program comprising:
code for determining a location of free space in a data file from a free space map (FSM) associated with a data file;
code for storing at least part of the object at the location in the data file;
code for updating the free space map to indicate that the location is no longer free; and
code for updating the multimedia message database to indicate the location of the object in the data file.

13. A computer program as claimed in claim 12, comprising code for maintaining a log file for undoing the storing, the log file indicating changes made to the free space map and the multimedia message database.

14. A computer program as claimed in claim 12, wherein the code for determining the location of free space in the data file comprises code for selecting the data file from a plurality of data files, each data file comprising a plurality of equally sized blocks.

15. A computer program as claimed in claim 14, wherein each data file is associated with a respective free space map, and the code for determining the location of free space comprises code for determining the location of free space in the selected data file from the associated free space map.

16. A computer program as claimed in claim 14, wherein the blocks in the respective data files comprise blocks of respective sizes.

17. A computer program as claimed in claim 14, comprising code for monitoring the plurality of data files, and marking data files as closed when they are full.

18. A computer program as claimed in claim 12, wherein the code for determining the location of free space comprises code for searching through the free space map from a random location.

19. A system for implementing the method as claimed in claim 1.

20. Computer readable storage storing a computer program as claimed in claim 12.
